(19) United States
(12) Patent Application Publication
(10) Pub. No.: US 2019/0142687 A1
(43) Pub. Date: May 16, 2019

(54) MASSAGE SOFA

(71) Applicants: COZZIA USA LLC, Covina, CA (US); XIAMEN COMFORT SCIENCE & TECHNOLOGY GROUP CO., LTD, Xiamen (CN)

(72) Inventors: Jianhan Zou, Xiamen (CN); Jianwen Xu, Xiamen (CN); Zhican Pan, Xiamen (CN); Decai Qiu, Xiamen (CN)

(21) Appl. No.: 16/171,372

(22) Filed: Oct. 26, 2018

(30) Foreign Application Priority Data
Nov. 15, 2017 (CN) 201721524571.0

(51) Int. Cl. A61H 9/00; A47C 17/86

(52) U.S. Cl. CPC A61H 9/0078; A47C 17/86; A61H 2201/0103; A61H 2205/081; A61H 2201/0207; A61H 2201/1409; A61H 2201/0149

(57) ABSTRACT

The invention provides a massage sofa having a seat portion and a backrest portion; the backrest portion has an accommodating cover, and the accommodating cover is provided with a baffle plate, and the baffle plate separates the accommodating cover into a first accommodating cavity and a second accommodating cavity, wherein the second accommodating cavity is located at a front side of the first accommodating cavity; a flocculating filler is disposed in the first accommodating cavity, a layered filler is disposed in the second accommodating cavity, the baffle plate is provided with a massage airbag, the massage airbag is located between the layered filler and the baffle plate, and the baffle plate is a baffle plate having a stiffness greater than a stiffness of the accommodating cover. The massage airbag of the massage sofa of the invention has a large massage force and the softness of the existing massage sofa.

### CROSS REFERENCE TO RELATED APPLICATIONS

The present application claims the benefit of Chinese Patent Application No. 201721524571.0 filed on Nov. 15, 2017. All the above are hereby incorporated by reference.

### TECHNICAL FIELD

The invention relates to the technical field of massage, in particular to a massage sofa.

### DESCRIPTION OF RELATED ART

The existing functional massage sofa has a seat with a cushion and an electric push rod, and a backrest chair equipped with a push rod or a wooden board, sponge and the like and having armrests on both sides. They are a kind of soft furniture. In combination with FIGS. 1 and 2, the existing massage sofa generally comprises a seat portion and a backrest portion. The backrest portion comprises an accommodating cover 1, a flocculent filler 2 which is soft and has good deformability is disposed in the accommodating cover 1 to support a user. The existing massage sofa is also equipped with a massage airbag. The conventional idea is to arrange the massage airbag in the flocculent filler 2, but in practice, the solution has the following disadvantages: since the flocculent filler 2 is relatively soft and has good deformability as a whole, after the massage airbag is inflated, it will push the flocculent filler to move forward and backward, which reduces the massage strength of the massage airbag to the user, leading to a problem of poor massage effect. Moreover, with the development of economy and technology, the functional requirements of users for sofa are getting higher and higher, but the function of the existing functional sofa is relatively simple. In view of this, the present application is provided.

### BRIEF SUMMARY OF THE INVENTION

The invention provides a massage sofa which can improve the massage strength of the massage airbag in view of the deficiencies of the prior art.

In order to solve the above-mentioned problem, the invention provides a massage sofa having a seat portion and a backrest portion, wherein the backrest portion has an accommodating cover 1, and the accommodating cover 1 is provided with a baffle plate 3 inside, and the baffle plate 3 separates the accommodating cover 1 into a first accommodating cavity L1 and a second accommodating cavity L2, wherein the second accommodating cavity L2 is located at a front side of the first accommodating cavity L1; a flocculent filler 2 is disposed in the first accommodating cavity L1, a layered filler 4 is disposed in the second accommodating cavity L2, the baffle plate 3 is provided with a massage airbag 5, the massage airbag 5 is located between the layered filler 4 and the baffle plate 3, and the baffle plate 3 is a baffle plate having a stiffness greater than the accommodating cover 1 so that a driving force generated when the massage airbag is inflated is less absorbed by the flocculent filler.

Further, as an executable solution, a heating member 6 capable of performing thermal radiation therapy on a user is disposed at a side close to the back S of the user between the accommodating cover 1 and the layered filler 4.

Further, as an executable solution, the accommodating cover 1 is an accommodating cover made of a nylon material.

Further, the embodiment of the invention further provides another massage sofa having a seat portion and a backrest portion; the backrest portion is provided with an accommodating cover 1 inside, and the accommodating cover 1 is provided with a baffle plate 3 inside, the baffle plate 3 separates the accommodating cover 1 to form a second accommodating cavity L2; the baffle plate 3 is provided with a massage airbag 5, the massage airbag 5 is located in the second accommodating cavity L2; the baffle plate 3 is a baffle plate having a stiffness higher than a stiffness of the accommodating cover 1.

Further, as an executable solution, a filler 4 is disposed in the second accommodating cavity L2, and the massage airbag 5 is located between the filler 4 and the baffle plate 3.

Further, as an executable solution, the baffle plate 3 separates the accommodating cover 1 into a first accommodating cavity L1 and the second accommodating cavity L2, a flocculent filler 2 is disposed in the backrest portion, and an outer side of the first accommodating cavity L1 abuts against the flocculent filler 2.

Further, as an executable solution, a heating member 6 capable of performing thermal radiation therapy on a user is disposed at a side of the accommodating cover 1 close to the back S of the user.

Further, as an executable solution, a filler 4 is disposed in the second accommodating cavity L2, and the massage airbag 5 is located between the filler 4 and the baffle plate 3, and the heating member 6 is disposed between the accommodating cover 1 and the filler 4.

Further, as an executable solution, the accommodating cover 1 is an accommodating cover made of a nylon material.

By adopting the above technical solution, the invention can achieve the following technical effects: since the stiffness of the baffle plate is greater than the stiffness of the accommodating cover, when the massage airbag is inflated, the driving force generated by the massage airbag will be less absorbed by the flocculent filler and can be mainly used to push the layered filler up to massage the back of the user, that is, the massaging strength of the massage airbag is greater; by arranging the layered filler in the first accommodating cavity, compared to filling of the flocculent filler, it can avoid the problem that the flocculent filler may not be restored to the initial state after the airbag is deflated; and by arranging the flocculent filler in the second accommodating cavity, the massage sofa is both soft and comfortable.

### BRIEF DESCRIPTION OF THE SEVERAL VIEWS OF THE DRAWINGS

In order to make the technical solutions of embodiments of the invention more clear, drawings to be used for description of embodiments will be introduced briefly hereinafter. Obviously, drawings used in the following description are merely some embodiments of the invention. Those skilled in the art also can conclude other drawings based on these drawings without paying creative labor.

FIG. 1 depicts a schematic diagram of a massage sofa;

FIG. 2 depicts a schematic diagram of an accommodating cover of a conventional massage sofa;

FIG. 3 depicts a schematic diagram of an accommodating cover of a massage sofa according to Embodiment 1 of the invention;

FIG. 4 depicts a schematic diagram of an accommodating cover of a massage sofa according to Embodiment 2 of the invention;

FIG. 5 depicts a schematic structure diagram of the accommodating cover of the massage sofa according to Embodiment 2 of the invention, arranged in the sofa.

### DETAILED DESCRIPTION OF THE INVENTION

In order to make the object, technical solutions and advantages of the invention clearer, the invention is further described in detail below with reference to the accompanying drawings. Obviously, the described embodiments are merely part but not all of the embodiments of the invention. All other embodiments obtained by a person of ordinary skill in the art based on the embodiments of the invention without creative efforts shall fall within the protection scope of the invention.

### Embodiment 1

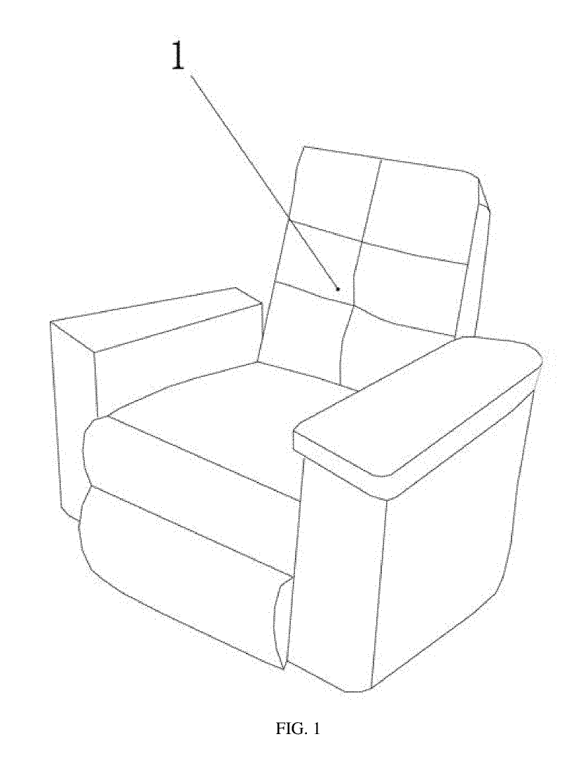

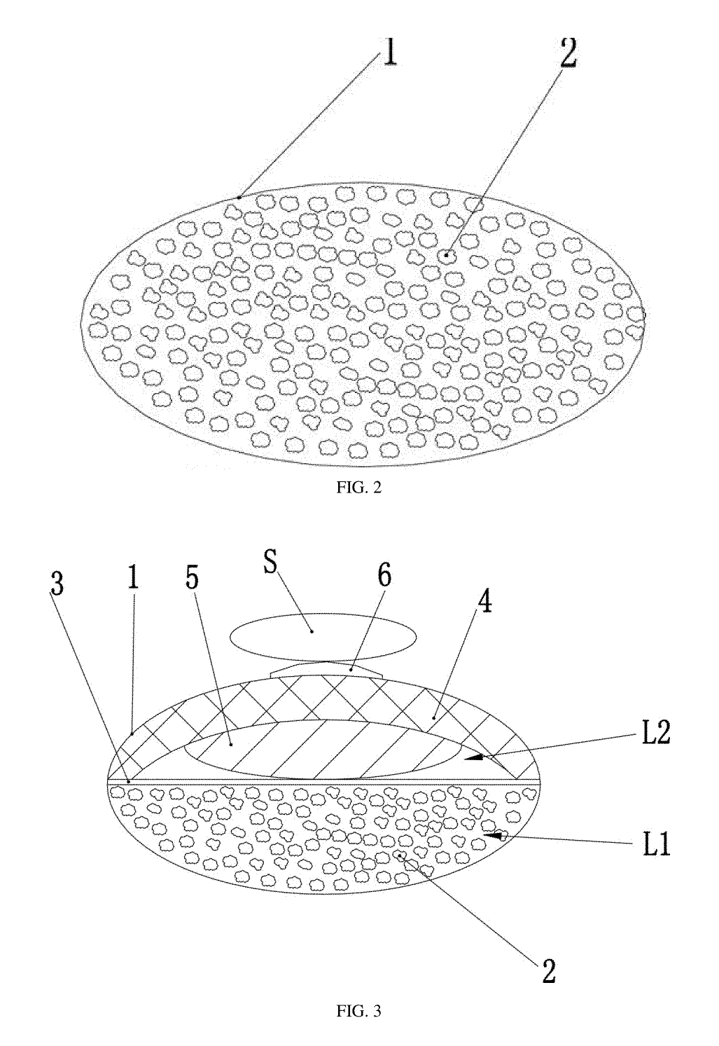

Embodiment 1 of the invention provides a massage sofa, in conjunction with FIG. 1 and FIG. 3, the massage sofa of the invention has a seat portion and a backrest portion, wherein the backrest portion has an accommodating cover 1, and the accommodating cover 1 is provided with a baffle plate 3 inside, and the baffle plate 3 separates the accommodating cover 1 into a first accommodating cavity L1 and a second accommodating cavity L2, wherein the second accommodating cavity L2 is located at a front side of the first accommodating cavity L1; a flocculent filler 2 is disposed in the first accommodating cavity L1, a layered filler 4 is disposed in the second accommodating cavity L2, the baffle plate 3 is provided with a massage airbag 5, the massage airbag 5 is located between the layered filler 4 and the baffle plate 3, and the baffle plate 3 is a baffle plate having a stiffness greater than a stiffness of the accommodating cover 1 so that a driving force generated by the massage airbag when the massage airbag is inflated is less absorbed by the flocculent filler.

In this embodiment, a heating member 6 capable of performing thermal radiation therapy on a user is disposed at a side of the accommodating cover 1 close to the back S of the user. The heating member 6 may be a heating member with a PTC heating plate.

The accommodating cover 1 may be an accommodating cover made of a nylon material, and the baffle plate 3 may be an accommodating cover made of a nylon material. The flocculent filler 2 is, for example, a common cotton fibre material such as pearl cotton. The layered filler is, for example, sponge.

Embodiment 1 of the invention provides a massage sofa. By adopting the above technical solution, since the stiffness of the baffle plate is greater than the stiffness of the accommodating cover, when the massage airbag is inflated, the driving force generated by the massage airbag will be less absorbed by the flocculent filler and can be mainly used to push the layered filler up to massage the back of the user, that is, the massaging strength of the massage airbag is greater; by arranging the layered filler in the first accommodating cavity, compared with filling of the flocculent filler, it can avoid the problem that the flocculent filler may not be restored to the initial state after the airbag is deflated; and by arranging the flocculent filler in the second accommodating cavity, the massage sofa is both soft and comfortable.

### Embodiment 2

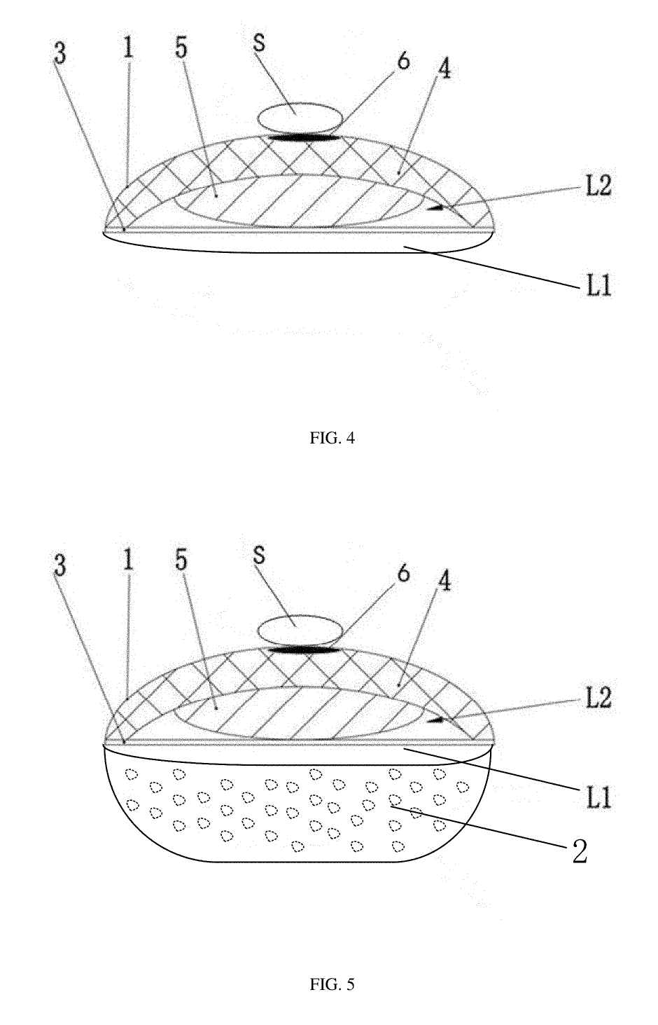

Embodiment 2 of the invention provides another massage sofa. In conjunction with FIG. 1 and FIG. 4, the massage sofa of the invention has a seat portion and a backrest portion; the backrest portion is provided with an accommodating cover 1 inside, and the accommodating cover 1 is provided with a baffle plate 3 inside, the baffle plate 3 separates the accommodating cover 1 to form a second accommodating cavity L2; the baffle plate 3 is provided with a massage airbag 5, and the massage airbag 5 is located in the second accommodating cavity L2; the baffle plate 3 is a baffle plate having a stiffness higher than a stiffness of the accommodating cover 1.

Since the stiffness of the baffle plate 3 is greater than the stiffness of the accommodating cover 1, this makes the baffle plate 3 less likely to be bent than the accommodating cover 1. When the massage airbag 5 is inflated, the driving force generated by the forward and backward expansion of the message airbag will be less absorbed by the flocculent filler, and can be mainly used to push the filler 4 toward the user's back to massage the back of the user. That is, the massaging strength of the massage airbag is greater.

Further, in an example, a filler 4 may be disposed in the second accommodating cavity L2, and the massage airbag 5 is located between the filler 4 and the baffle plate 3.

Specifically, the baffle plate 3 separates the accommodating cover 1 into a first accommodating cavity L1 and the second accommodating cavity L2, a flocculent filler 2 is disposed in the backrest portion, and an outer side of the first accommodating cavity L1 abuts against the flocculent filler 2 in the backrest portion. Only a portion of the flocculent filler 2 is shown in FIG. 5. This makes the massage sofa both soft and comfortable.

Further, in this embodiment, the filler 4 is a layered filler, such as a filler that may be a sponge material. By disposing the filler in the second accommodating cavity L2, compared with the filling of the flocculent filler, it can avoid the problem that the flocculent filler may not be restored to the initial state after the airbag is deflated. Referring again to FIG. 5 which shows a cross-sectional view of the accommodating cover 1 placed in the back of the sofa and combined with the flocculent filler disposed in the back of the sofa, the flocculent filler 2 is disposed outside the first accommodating cavity L1 of the accommodating cover 1, and this makes the massage sofa both soft and comfortable.

Further, in this embodiment, a heating member 6 capable of performing thermal radiation therapy on a user is disposed at a side of the accommodating cover 1 close to the back S of the user. More specifically, a filler 4 is disposed in the second accommodating cavity L2, and the massage airbag 5 is located between the filler 4 and the baffle plate 3, and the heating member 6 is disposed between the accommodating cover 1 and the filler 4. The heating member 6 here may be a heating member with a PTC heating plate. Due to combination with the airbag, the massage sofa is comfortable and also has the massaging function, and therefore the functional sofa has more functions and achieves the effect of the waist massaging and heating, thereby giving the user a better massage experience.

Further, as an executable solution, the accommodating cover 1 may be a accommodating cover made of a nylon material, in particular, a multi-layer nylon cloth cover, and the baffle plate 3 may be made of wool felt or nylon material. The flocculent filler 2 is an existing sofa filler, for example, a common cotton fiber material such as pearl cotton. The layered filler 4 may be a material such as sponge. Of course, the above materials are merely illustrative of the materials used in the invention, and the embodiments of the invention do not limit the materials used.

Further, it should be noted that the accommodating cover 1, the baffle plate 3, the massage airbag 5, and the like according to the invention all can be sewn together by means of a sewing machine, and the corresponding fillers are filled into the corresponding accommodating cavities.

In addition, the accommodating cover of the invention is a separate component, and can be directly disposed on the front side of the flocculent filler in the backrest portion of the massage sofa, so that the massage sofa becomes both soft and comfortable.

In the massage sofa according to the embodiments of the invention, since the stiffness of the baffle plate is greater than the stiffness of the accommodating cover, when the massage airbag is inflated, the driving force generated by the massage airbag will be less absorbed by the flocculent filler and can be mainly used to push the layered filler up to massage the back of the user, that is, the massaging strength of the massage airbag is greater; by arranging the layered filler in the second accommodating cavity, compared with filling of the flocculent filler, it can avoid the problem that the flocculent filler may not be restored to the initial state after the airbag is deflated; and by arranging the accommodating cover on the front side of the flocculent filler disposed in the massage sofa, the massage sofa becomes both soft and comfortable. In addition, by arranging the heating member on a side of the accommodating cover close to the layered filler, the massage sofa can perform thermal radiation therapy on the user, and in combination with the airbag, the massage sofa becomes comfortable and also has the massaging function. Furthermore, the accommodating cover of the invention is a separate component, and can be directly disposed on the front side of the flocculent filler in the backrest portion of the massage sofa, so that the massage sofa becomes both soft and comfortable.

What is claimed is:

1. A massage sofa having a seat portion and a backrest portion, wherein the backrest portion has an accommodating cover (1), and the accommodating cover (1) is provided with a baffle plate (3) inside, and the baffle plate (3) separates the accommodating cover (1) into a first accommodating cavity (L1) and a second accommodating cavity (L2), wherein the second accommodating cavity (L2) is located at a front side of the first accommodating cavity (L1); the accommodating cover (1) is provided with a massage airbag (5) inside, the massage airbag (5) is located between the accommodating cover (1) and the baffle plate (3), and the baffle plate (3) has a stiffness greater than a stiffness of the accommodating cover (1) so that a driving force generated by the massage airbag when the massage airbag is inflated is less absorbed by the baffle plate (3).

2. The massage sofa according to claim 1, wherein a layered filler (4) is disposed in the second accommodating cavity (L2), the layered filler (4) is located between the accommodating cover (1) and the massage airbag (5).

3. The massage sofa according to claim 1, wherein a heating member (6) capable of performing thermal radiation therapy on a user is disposed at a side close to the back (S) of the user between the accommodating cover (1) and the layered filler (4).

4. A massage sofa having a seat portion and a backrest portion, wherein the backrest portion is provided with an accommodating cover (1) inside, the accommodating cover (1) is provided with a baffle plate (3) inside, the baffle plate (3) separates the accommodating cover (1) to form a second accommodating cavity (L2); the baffle plate (3) is provided with a massage airbag (5), the massage airbag (5) is located in the second accommodating cavity (L2); the baffle plate (3) has a stiffness higher than a stiffness of the accommodating cover (1).

5. The massage sofa according to claim 4, wherein a filler (4) is disposed in the second accommodating cavity (L2), and the massage airbag (5) is located between the filler (4) and the baffle plate (3).

6. The massage sofa according to claim 4, wherein the baffle plate (3) separates the accommodating cover (1) into a first accommodating cavity (L1) and the second accommodating cavity (L2), a flocculent filler (2) is disposed in the backrest portion, and an outer side of the first accommodating cavity (L1) abuts against the flocculent filler (2).

7. The massage sofa according to claim 5, wherein the filler (4) is a layered filler.

8. The massage sofa according to claim 4, wherein a heating member (6) capable of performing thermal radiation therapy on a user is disposed at a side of the accommodating cover (1) close to the back (S) of the user.

9. The massage sofa according to claim 4, wherein a filler (4) is disposed in the second accommodating cavity (L2), the massage airbag (5) is located between the filler (4) and the baffle plate (3), and the heating member (6) is arranged between the accommodating cover (1) and the filler (4).

10. The massage sofa according to claim 4, wherein the accommodating cover (1) is an accommodating cover made of a nylon material.
